(19) United States
(12) Patent Application Publication
(10) Pub. No.: US 2020/0311801 A1
(43) Pub. Date: Oct. 1, 2020

(54) POINT REMINDER SYSTEM OF ONLINE SHOPPING

(71) Applicant: Chyuan-Feng Tsay, New Taipei City (TW)

(72) Inventor: Chyuan-Feng Tsay, New Taipei City (TW)

(21) Appl. No.: 16/367,222

(22) Filed: Mar. 27, 2019

(51) Int. Cl. G06Q 30/06; G06Q 30/02; G06F 16/955

(52) U.S. Cl. CPC G06Q 30/0633; G06Q 30/0236; G06F 16/9554; G06Q 30/0226

(57) ABSTRACT

An online shopping point reminder system includes: an online shopping server, an online shopping server managed by an operator to enable a first user and a seller to register as members. The seller and the operator individually provide sales of at least one first commercial article and a second commercial article. The first user is rewarded with a shopping point through making a consumption. The first user may share the shopping webpage with other users. When second and third users make consumptions in the shopping webpage, a shopping point is rewarded to the first user; and when a fourth user makes a consumption, a lost shopping point is displayed on a mobile electronic device of the first user to allow the first user to subsequently claim the shopping point derived from the consumption made by the fourth user after the first user makes a purchase of the second commercial article.

### (a) TECHNICAL FIELD OF THE INVENTION

The present invention relates generally to an online shopping system, and more particularly to a mechanism that rewards a user with a shopping point and a recommendation point after making consumption or sharing and a mechanism for reminder of loss of the shopping point, in order to urge the user to purchase a second commercial article to acquire more shopping points.

### (b) DESCRIPTION OF THE PRIOR ART

Network shopping or online shopping features excellent convenience and is now becoming new behavior of consumers. According to statistics regarding digital divide, around 62.7% of the netizens have purchases commercial articles through online shopping. Apparently, online shopping is now worldwide movement, and this brings up a large number of e-commerce platforms, which involve various operation modes, including, among other things, B2B, B2C, and C2C. A platform operator often has to make promotion by offering various preferential measures in order to increase interest of buyers for making online shopping for attracting more consumers to use the platforms, of which shopping bonus point accumulation mode is one of the most commonly used measure. When the amount of consumption made by a consumer reaches a specific level, the consumer is rewarded with a bonus point, which may be used for deduction or trade-in purpose in a preset period of time.

However, known online shopping system with award or bonus feedback mechanism often suffer the following disadvantages. (1) Firstly, a recommendee must provide information of a recommender, such as account number, and the recommender may be rewarded with the feedback bonus or reward only after the recommendee has successfully completed shopping. However, it is not uncommon that the recommendee forgets to provide the required information and the recommender does not get the bonus. (2) Secondly, the profit-sharing mechanisms are quite inflexible in respect of the profit sharing conditions, and the user may not be aware of loss of the feedback bonus or point and would generally be not very interested in using such a mechanism.

### SUMMARY OF THE INVENTION

In view of the above drawbacks, the present invention provides an online shopping point reminder system, which comprises: an online shopping server, which is run and managed by an operator and is provided to enable a first user and a seller to register as members of a shopping webpage, wherein the seller and the operator individually provide sales of at least one first commercial article and a second commercial article, so that when the first user, after making a consumption, is rewarded with a predetermined amount of shopping points; and the first user may shares a web address or QR code of the shopping webpage through a mobile electronic device to enable a second user to register as a member, and so on, so that the second user may make further sharing to enable a third user to register as a member, and the third user also makes further sharing to enable a fourth user to register as a member. When the second and third users make consumptions in the shopping webpage, a shopping point of at least 0.1% of the consumption amounts would be rewarded to the first user; and when the fourth user makes a consumption, a lost shopping point is displayed on the mobile electronic device of the first user to allow the first user to subsequently claim the shopping point derived from the consumption made by the fourth user (and subsequent users) after the first user makes a purchase of a second commercial article.

The primary purpose of the online shopping point reminder system of the present invention as follows: The present invention helps prompt the support of a shopping webpage by consumers to thereby enhance consumption percentage, and makes each user actively share a web address and QR code of the shopping webpage with others so as to gain a quick increase of the number of members, while allowing the users to gain a preset amount of shopping points and recommendation points.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing connection of a point reminder system of online shopping according to the present invention.

FIG. 2 is a schematic view showing a system architecture of the point reminder system of online shopping according to the present invention.

FIG. 3 is a schematic view illustrating account data of a first user of the point reminder system of online shopping according to the present invention.

FIG. 4 is a schematic view illustrating a use condition of the first user of the point reminder system of online shopping according to the present invention.

FIG. 5 is a flow chart view illustrating a first user recommends a second user in the point reminder system of online shopping according to the present invention.

FIG. 6 is a flow chart view illustrating the second user recommends a third user in the point reminder system of online shopping according to the present invention.

FIG. 7 is a flow chart view illustrating the third user recommends a fourth user in the point reminder system of online shopping according to the present invention.

FIG. 8 is a schematic view illustrating a condition of use of the second and third users of the point reminder system of online shopping according to the present invention.

FIG. 9 is a schematic view illustrating a condition of use of the fourth user of the point reminder system of online shopping according to the present invention.

FIG. 10 is a schematic view illustrating the first user of the point reminder system of online shopping according to the present invention purchasing a first commercial article.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

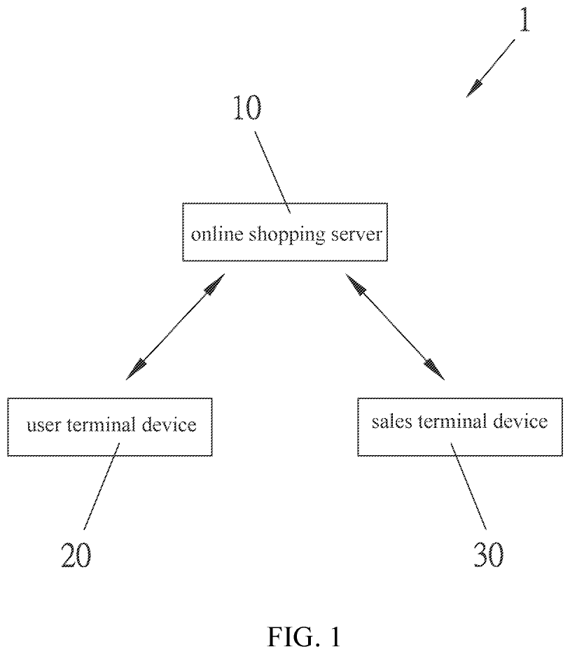

Referring to FIG. 1, the present invention provides an online shopping point reminder system 1, which comprises: an online shopping server 10, at least one user terminal device 20, and at least one sales terminal device 30.

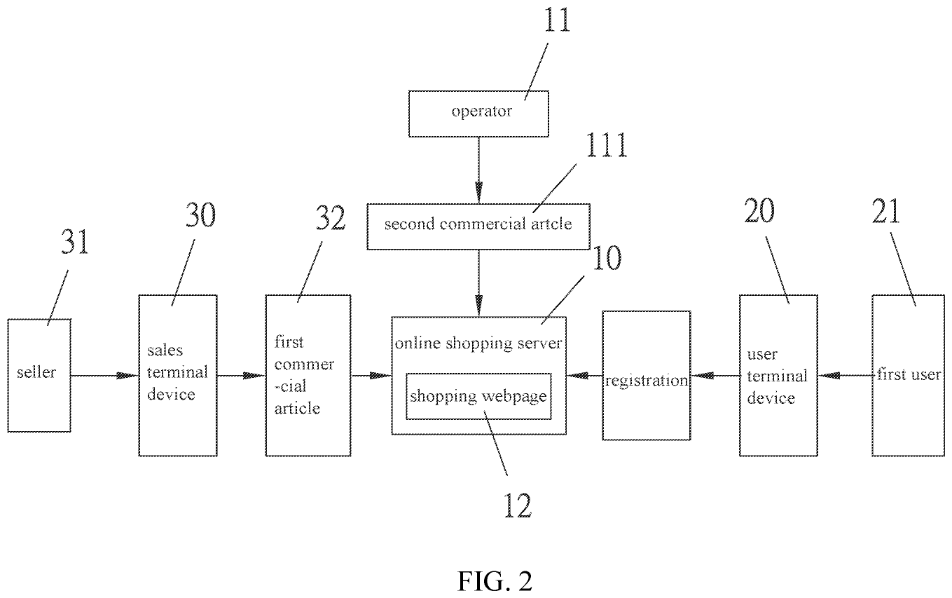

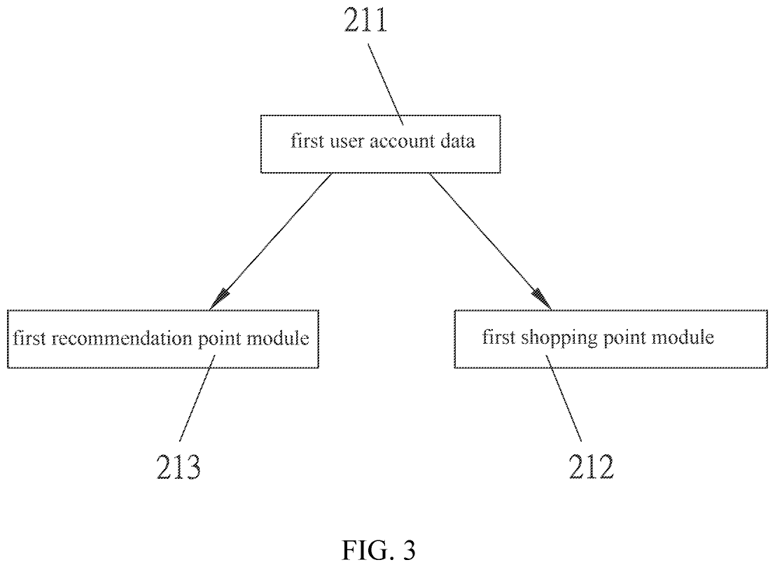

Referring to FIGS. 2 and 3, the online shopping server 10 is operated and run by an operator 11. The online shopping server 10 comprises at least one processor (not shown) and at least one storage element (not shown). The storage element and the processor are electrically connected. The storage element stores a software program (not shown). When the processor executes the software program, the following mechanism is achieved:

providing a shopping webpage 12 that comprises shopping information to a user terminal device 20 and at least one sales terminal device 30, wherein the shopping webpage 12 is provided to enable a first user 21 to register first user account data 211 to become a member of the shopping webpage 12 and the first user account data 211 comprise a first shopping point module 212 and a first recommendation point module 213.

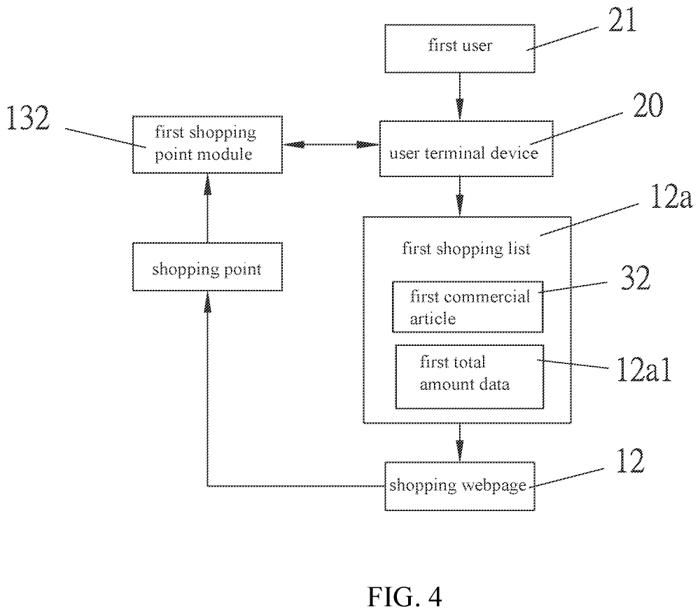

Referring to FIGS. 2-4, the shopping webpage 12 is provided to allow a seller 31 to shelf at least one first commercial article 32 through the sales terminal device 30 and allow the operator 11 to shelf at least one second commercial article 111, and the shopping webpage 12 is also provided to receive a first shopping list 12a that includes at least one first commercial article 32 and a first total amount data 12a1 of the first shopping list 12a from the user terminal device 20, wherein the software program calculates a profit data by subtracting a cost price of the first commercial article 32 from the first total amount data 12a1 and the software program calculates a shopping point as at least 0.1% of the profit data to be deposited and stored in the first shopping point module 212 of the first user 21. In other words, the first user 21 may acquire more shopping points through making greater consumption in the shopping webpage 12, and the shopping points can be used to deduct the first total amount data 12a1 spent in the shopping webpage 12, so that the interest of the consumer in making purchases can be increased.

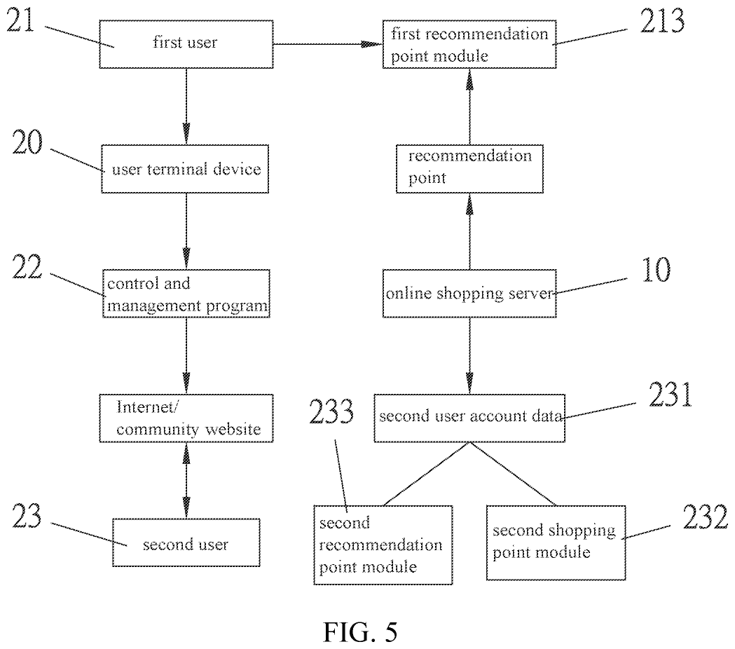

Referring to FIG. 5, the user terminal device 20 and the sales terminal device 30 are each an electronic device (not shown), which comprises a communication unit (not shown), a touch screen (not shown), a processing unit (not shown) electrically connected with the communication unit and the touch screen, and a control and management program 22 (such as a mobile application program, APP) executed by the processing unit. Execution of the control and management program 22 achieves the following mechanism:

the first user 21 transmitting a web address or QR code of the shopping webpage 12 to the internet or a community website through sharing with the control and management program 22, so as to enable at least one second user 23 to connect through the web address or QR code to the online shopping server 10 to register second user account data 231;

wherein after the second user 23 has registered the second user account data 231 and the software program has confirmed, through operation, the second user account data 231, at least one recommendation point is deposited and stored in the first recommendation point module 213 of the first user 21.

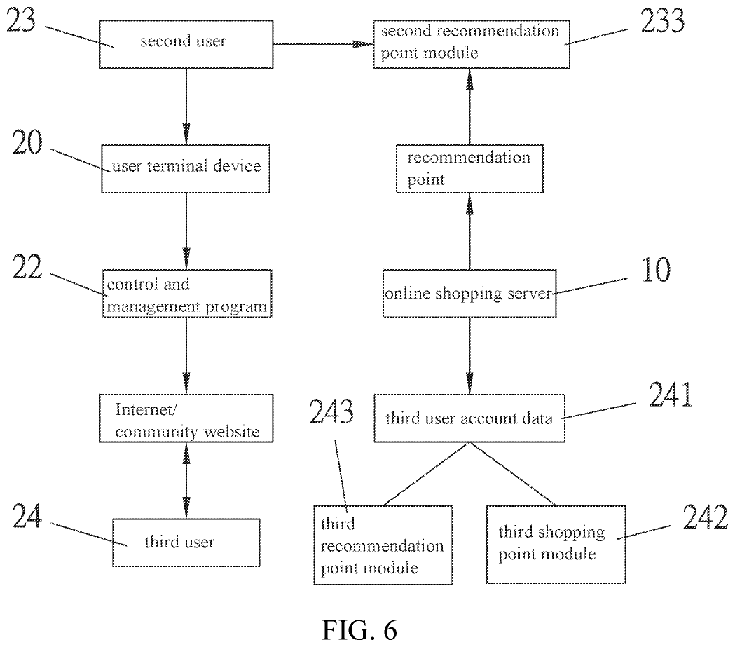

Referring to FIG. 6, the second user 23 may then transmit the web address or QR code of the shopping webpage 12 to the internet or a community website through sharing with the control and management program 22, so as to enable at least one third user 24 to connect through the web address or QR code to the online shopping server 10 to register third user account data 231.

After the third user 24 has registered the third user account data 241 and the software program has confirmed, through operation, the third user account data 241, at least one recommendation point is deposited and stored in the second recommendation point module 233 of the second user 23.

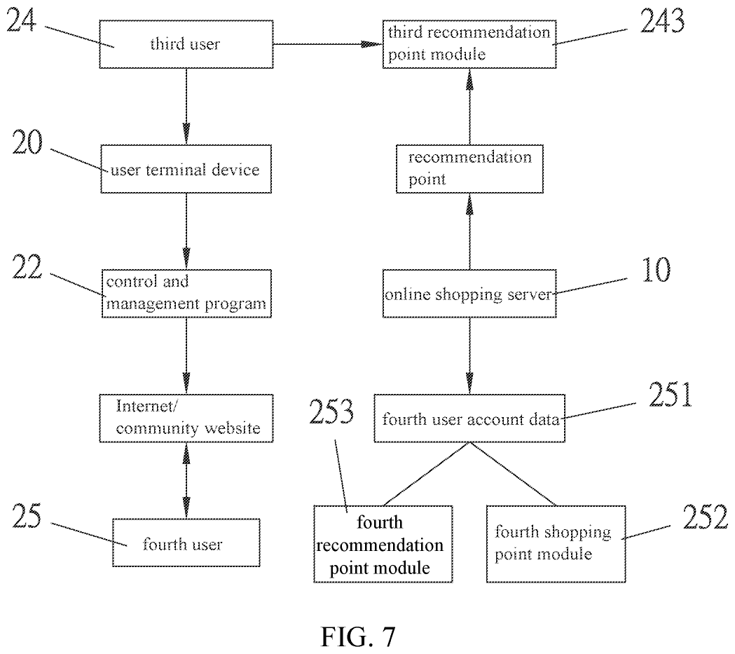

Referring to FIG. 7, the third user 24 may then transmit the web address or QR code of the shopping webpage 12 to the internet or a community website through sharing with the control and management program 22, so as to enable at least one fourth user 25 to connect through the web address or QR code to the online shopping server 10 to register fourth user account data 251.

After the fourth user 25 has registered the fourth user account data 251 and the software program has confirmed, through operation, the fourth user account data 251, at least one recommendation point is deposited and stored in the third recommendation point module 243 of the third user 24.

The first user 21, the second user 23, the third user 24, and the fourth user 25 have a linking relationship in respect of the sequence thereof, and thus, it is specifically noted the sequence of being registered as members in the shopping webpage 12 among the first user 21, the second user 23, the third user 24, and the fourth user 25.

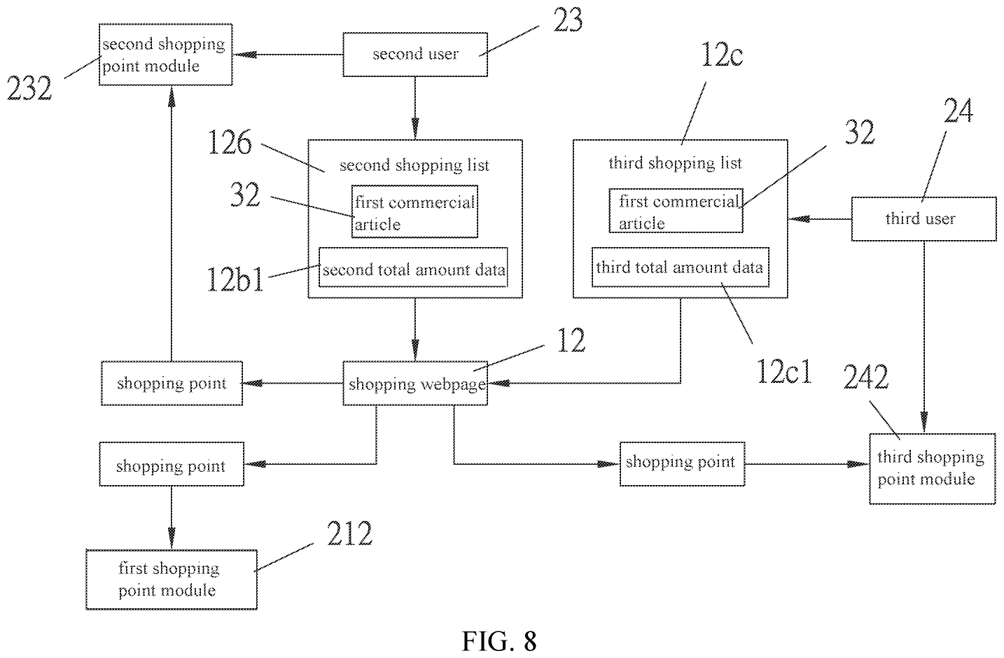

Referring to FIG. 8, the second user 23 and the third user 24 respectively transmit a second shopping list 12b that comprises a first article 32 and a second total amount data 12b1 thereof and a third shopping list 12c that comprises a first article 32 and a third total amount data 12c1 thereof back to the shopping webpage. The software program calculates a shopping point of at least 0.1% of the second total amount data 12b1 and the third total amount data 12c1 to be deposited and stored in the first shopping point module 212 of the first user 21, the second shopping point module 232 of the second user 23, and the third shopping point module 242 of the third user 241.

In other words, in addition to the second user 23 and the third user 24 being awarded and acquiring an individual shopping point through consumption in the shopping webpage 12, the first user 21 is also rewarded with and acquires a shopping point with the consumptions made by the second user 23 and the third user 24, and the second user 23 is also rewarded with and acquires a shopping point through the consumption made by the third user 24.

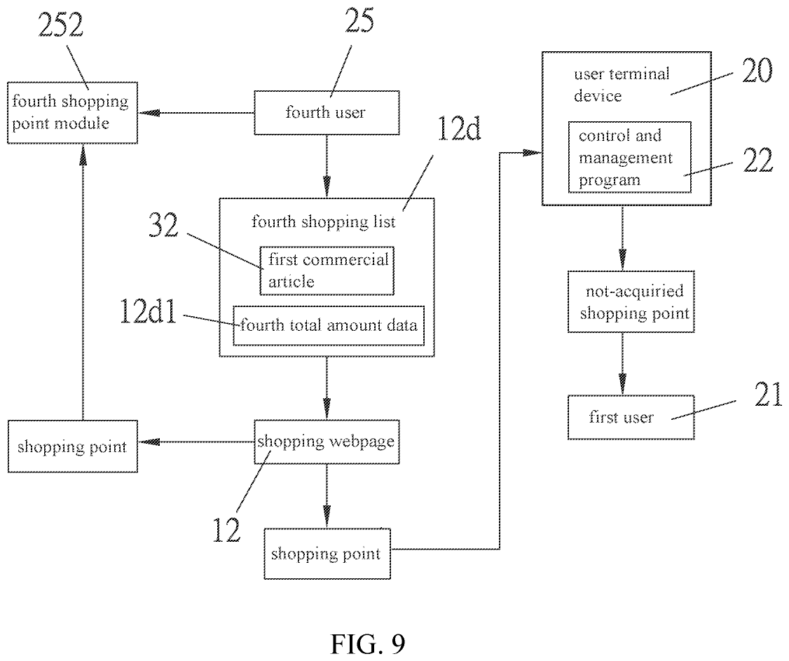

Referring to FIG. 9, the fourth user 25 transmits a fourth shopping list 12d that comprises at least one first commercial article 32 and a fourth total amount data 12d1 thereof back to the shopping webpage 12. The software program calculates a shopping point of at least 0.1% of the fourth total amount data 12d1 to be deposited and stored in a fourth shopping point module of the fourth user 25 and also display data of the shopping point on the user terminal device 20 of the first user 21 to remind the first user 21 of non-acquired shopping points (and it is also possible to display, in the control and management program 22, remarks of characters or words, such as “lost shopping points, not-claimed shopping points, or not-acquired shopping points”, but not limited thereto).

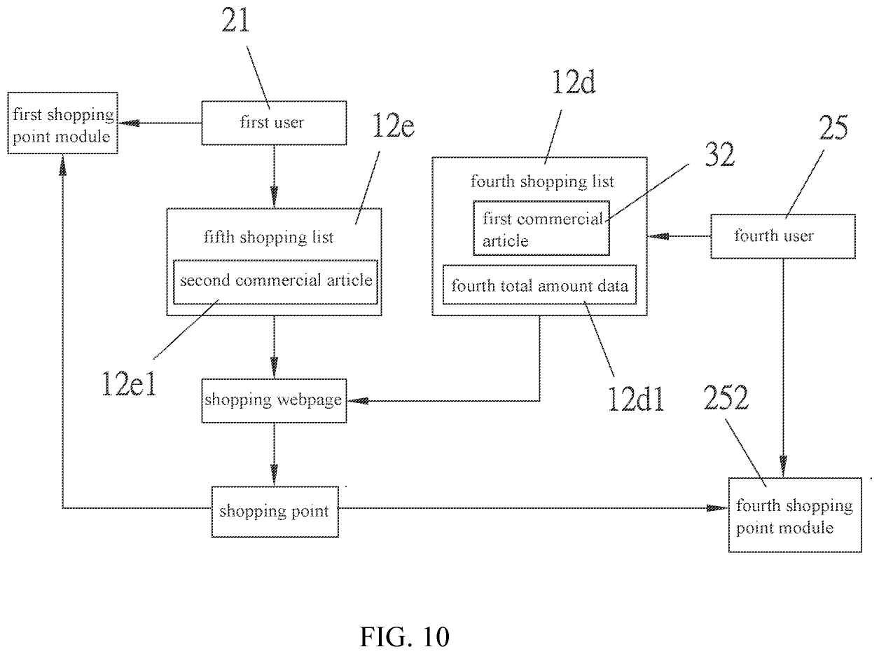

Referring to FIG. 10, when the first user 21 transmits a fifth shopping list 12e1 that comprises at least a second commercial article 111 back to the shopping webpage 12, the software program, after making confirmation, through operation thereof, deposits and stores the not-acquired shopping points in the first shopping point module 213 of the first user 21. In other words, the first user 21 is rewarded with a shopping point when he or she purchases the first commercial article 32 himself or herself; the first user 21 is also rewarded with shopping points when the second user 23 and the third user 24 purchase the first commercial article 32; but the first user 21 is rewarded a shopping point when the fourth user 25 purchases the first commercial article 32 only after the first user 21 purchases a second commercial article 111. Therefore, if the first user 21 does not make a purchase of the second commercial article 111, then the user terminal device 20 is displayed with a not-acquired shopping point, so that when the first user 21 sees the not-acquired shopping point displayed on the user terminal device 20, the first user 21 may be excited to bring up interesting in purchasing the second commercial article 111. Such a reminder function of “displaying a non-acquired shopping point on a user terminal device 20” is the primary purpose of this invention and would make it clear to a consumer of the shopping points that could be acquired through consumption of the first commercial article 32 and the second commercial article 111, so as to enhance the willingness of shopping in the shopping webpage 12.

In the instant embodiment, it is set that after the consumption made by the fourth user 25, the first user 21 needs to purchase a second commercial article 111 in order to acquire the shopping point rewarded for the consumption of the fourth user 25; however, it may not need to be limited to the fourth user 25, and it could also be the third user 24, or a user sequenced posterior to the fourth user 25.

In addition, this invention may also allow setting up a termination mechanism. For example, after the first user 21 has purchases the second commercial article 111, it is possible to acquire all the shopping points posterior to the consumption made by the fourth user 25 and as such, acquiring is available for the shopping points rewarded through consumptions made since then by consumers to at least an eighth user (not shown), but not limited thereto.

In the instant embodiment, the online shopping server 10 can be combined with at least one physical shop. Thus, the first user 21, when purchasing a first commercial article 32 in the physical shop, is also rewarded with a shopping point, and the shopping point can be deposited and stored through the control and management program in the first shopping point module 212. And, with consumptions made by the second user 23 and the third user 24, the first user 21 is also rewarded with a shopping points by means of individual consumption of each of the second user 23 and the third user 24, while the second user 23 and the third user 24 are each rewarded with a shopping point; and when the fourth user 25 makes a consumption, only the second user 23, the third user 24, and the fourth user 25 are each rewarded with a shopping point, and the online shopping server 10 issues a message to the control and management program 22 of the first user 21 to remind the first user of a not-acquired amount of the shopping point available from the fourth user 25, and the first user 21 purchases a second commercial article 111, the not-acquired shopping points is reset and the, after the fourth user 25 transmits a fourth shopping list 12d that comprises at least one first commercial article 32 and a fourth total amount data 12d1 thereof back to the shopping webpage 12, the software program calculates a shopping point of at least 0.1% of the fourth total amount data 12d1 to be deposited and stored in the first shopping point module 212 of the first user 21.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An online shopping point reminder system, comprising:
an online shopping server, which is run by an operator, the online shopping server comprising at least one processor and at least one storage element, the storage element and the processor being electrically connected together, the storage element storing therein a software program, wherein execution of the software program with the processor, the following mechanism is achieved: providing a shopping webpage that comprises shopping information to a user terminal device and at least one sales terminal device, wherein the shopping webpage is provided to enable a first user to register first user account data to become a member of the shopping webpage and the first user account data comprise a first shopping point module and a first recommendation point module; and the shopping webpage allows a seller to shelf at least one first commercial article through the sales terminal device and allow the operator to shelf at least one second commercial article, and the shopping webpage receives a first shopping list that includes at least one first commercial article and a first total amount data of the first shopping list from the user terminal device, wherein the software program calculates a profit data by subtracting a cost price of the first commercial article from the first total amount data and the software program calculates a shopping point as at least 0.1% of the profit data to be stored in the first shopping point module of the first user;
the user terminal device and the sales terminal device being each an electronic device, which comprises a communication unit, a touch screen, a processing unit electrically connected with the communication unit and the touch screen, and a control and management program executable by the processing unit, such that execution of the control and management program achieves the following mechanism: the first user transmitting a web address or QR code of the shopping webpage to the internet or a community website through sharing with the control and management program, so as to enable at least one second user to connect through the web address or QR code to the online shopping server to register second user account data, the second user account data comprising a second shopping point module and a second recommendation point module;
the second user transmitting the web address or QR code of the shopping webpage to the internet or a community website through sharing with the control and management program, so as to enable at least one third user to connect through the web address or QR code to the online shopping server to register third user account data, the third user account data comprising a third shopping point module and a third recommendation point module;
the third user transmitting the web address or QR code of the shopping webpage to the internet or a community website through sharing with the control and management program, so as to enable at least one fourth user to connect through the web address or QR code to the online shopping server to register fourth user account data, the fourth user account data comprising a fourth shopping point module and a fourth recommendation point module;
the second user and the third user respectively transmitting a second shopping list that comprises a first article and a second total amount data thereof and a third shopping list that comprises a first article and a third total amount data thereof back to the shopping webpage, the software program calculating a shopping point of at least 0.1% of the second total amount data and the third total amount data to be deposited and stored in the first shopping point module of the first user, the second shopping point module of the second user, and the third shopping point module of the third user;
the fourth user transmitting a fourth shopping list that comprises at least one first commercial article and a fourth total amount data thereof back to the shopping webpage, the software program calculating a shopping point of at least 0.1% of the fourth total amount data to be deposited and stored in the fourth shopping point module of the fourth user and also displaying data of the shopping point on the user terminal device of the first user to remind the first user of a not-acquired shopping point;
wherein when the first user transmits a fifth shopping list that comprises at least one second commercial article back to the shopping webpage, the software program makes confirmation through calculation to reset the not-acquired shopping point, and when the fourth user transmits a fourth shopping list that comprises at least one first commercial article and a fourth total amount data thereof back to the shopping webpage, the software program calculates a shopping point of at least 0.1% of the fourth total amount data to be deposited and stored in the first shopping point module of the first user.

2. The online shopping point reminder system according to claim 1, wherein after the second user has registered the second user account data and the software program has confirmed, through operation, the second user account data, at least one recommendation point is deposited and stored in the first recommendation point module of the first user.

3. The online shopping point reminder system according to claim 1, wherein after the third user has registered the third user account data and the software program has confirmed, through operation, the third user account data, at least one recommendation point is deposited and stored in the second recommendation point module of the second user.

4. The online shopping point reminder system according to claim 1, wherein after the fourth user has registered the fourth user account data and the software program has confirmed, through operation, the fourth user account data, at least one recommendation point is deposited and stored in the third recommendation point module of the third user.
